(19) United States
(12) Patent Application Publication
(10) Pub. No.: US 2009/0090417 A1
(43) Pub. Date: Apr. 9, 2009

(54) Sanitary replaceable fluid disbursement device for use in bioreactors

(75) Inventors: Kevin J. McGuffin, Cheshire, CT (US); John E. Rosenberger, Plantsville, CT (US); Todd W. Pflugbeil, Bristol, CT (US); Dennis J. Ogurick, Meriden, CT (US); Kenneth L. Rubow, Avon, CT (US)

Correspondence Address: WILMERHALE/BOSTON, 60 STATE STREET, BOSTON, MA, 02109, US

(73) Assignee: Mott Corporation, Farmington, CT (US)

(21) Appl. No.: 11/907,056

(22) Filed: Oct. 9, 2007

(51) Int. Cl. F16K 43/00

(52) U.S. Cl. 137/315.01; 239/600; 137/561 R; 285/404

(57) ABSTRACT

Methods and systems for easily replacing fluid disbursement devices used in a sanitary bioreactor are presented. The system includes a fluid disbursement device, a tube adapter, a wand adapter. The fluid disbursement device is fixed to the tube adapter. The tube adapter and wand adapter are essentially complementary and are releasably connected. The combined fluid disbursement device and tube adapter unit is easily replaceable during the cleaning and sterilization of the bioreactor. An O-ring, located in an O-ring grove, provides an impermeable boundary between the wand adapter and the tube adapter.

### BACKGROUND

1. Field of Invention

This invention generally relates to replaceable fluid disbursement assemblies and quick disconnect couplings for use in systems with sanitary requirements, such as biological or pharmaceutical reactor vessels.

2. Description of Related Art

Many industrial processes in the biotechnology and pharmaceutical industries rely on specialized process vessels, called reactor vessels, where the underlying chemical and biological reactions take place. The reactor vessels can range from a few liters to nearly 1000 m³ depending on the particular applications. Those applications include conventional chemical reactions, along with both aerobic and anaerobic biological processes. Specific examples of such reactions include the culture of yeast or fungi to make beer and other alcoholic drinks or the culture of animal cells or bacteria, to make particular chemicals, vitamins, and proteins.

In addition to the reactor vessels, additional equipment and systems are required to deliver growth media, extract the final products, and dispose of waste products. In particular, many processes require the use of fluid disbursement elements, such as porous metal or ceramic spargers, to introduce liquids and/or gases into the reactor vessel in a controlled manner during the reaction process. The sparger is attached to the end of a tubular wand passing through the wall of the reactor vessel. The tubular wand is mounted in an access port on the side of the reactor vessel with a sanitary, leak-proof fitting known in the art such as a compression, Ingold™, Tri-Clover™, or other sanitary type fitting. Tri-Clover is a registered trademark of Alfa Laval, Inc. The liquid or gas flows from an external reservoir and into the interior of the reactor vessel, passing through the wand and the sparger.

The interior of the reactor vessel generally must be cleaned and sterilized at the completion of a reaction cycle before the initiation of the next cycle. This is typically accomplished by withdrawing the wand and the attached fluid disbursement device from the reactor vessel. A second wand, with an attached spray ball, is inserted through which high pressure detergents or cleaning fluids can be injected into the reactor vessel. At the completion of the cleaning cycle, the spray ball is withdrawn. The original wand, with a new porous metal or ceramic sparger, is inserted back into the reactor vessel. A new sparger is generally required, as the small holes and other crevices in the sparger are difficult to clean. What follows is a sterilization cycle in which high temperature steam is injected into the wetted areas of the reactor systems including the tank. Steam is introduced through several port openings and in some cases through the sparger wand.

In addition, the cleaning and sterilization requirement of biotechnology and pharmaceutical processes eliminates the use of threads and clamps as mounting devices within the reactor vessel. For example, the threads and other crevices found on standard connectors provide areas that cleaning fluids and sterilizing steam can not reach. This has generally resulted in the use of welds to attach the fluid disbursement devices to the wands that are inserted within the reactor vessel. The use of welded designs requires cutting and re-welding when it becomes necessary to remove a fluid disbursement device from a wand for replacement, for example between process cycles. In addition two wand assemblies are required, one for the sparger type device used during the process cycle and one for the spray ball device used during the cleaning process.

### BRIEF SUMMARY

The invention provides replaceable fluid disbursement assemblies and quick disconnect couplings for use in systems with sanitary requirements, such as biological or pharmaceutical reactor vessels.

Under one aspect of the invention a system for easily replacing fluid disbursement devices used in a sanitary bioreactor includes a fluid disbursement device, a tube adapter, a wand adapter. The fluid disbursement device is fixed to the tube adapter. The tube adapter and wand adapter are essentially complementary and are releasably connected. An O-ring, located in an O-ring grove, provides an impermeable boundary between the wand adapter and the tube adapter. The system further includes a fastener that passes through the wand adapter fastener hole and the tube adapter fastener hole to prevent the wand adapter and the tube adapter from separating during normal operation. The system may include wand adapter and tube adapter flanges.

Under an additional aspect of the invention a sanitary quick disconnect coupling for use in a bioreactor includes a wand adapter having an interior surface defining an axially extending passage, an exterior surface containing an O-ring grove, and a fastener hole. The coupling further includes a tube adapter having an interior, and an exterior surface containing a fastener hole. The wand adapter and tube adapter are essentially complementary, and an O-ring located in the O-ring grove provides an impermeable boundary between the wand adapter and the tube adapter. The system further includes a fastener that passes through the wand adapter fastener hole and the tube adapter fastener hole to prevent the wand adapter and the tube adapter from separating during normal operation.

These and other features will become readily apparent from the following detailed description where embodiments of the invention are shown and described by way of illustration.

### BRIEF DESCRIPTION OF THE SEVERAL VIEWS OF THE DRAWINGS

For a more complete understanding of various embodiments of the present invention, reference is now made to the following descriptions taken in connection with the accompanying drawings in which:

FIG. 1 is a perspective view, partly in cross section, of a replaceable fluid disbursement assembly installed within a reactor vessel in accordance with one or more embodiments of the invention.

FIG. 2 is a perspective view of a replaceable fluid disbursement assembly in accordance with one or more embodiments of the invention.

FIG. 3 is an elevation view, in cross section, of the replaceable fluid disbursement assembly of FIG. 2.

FIG. 4 is a perspective view of the tube adapter of FIG. 2.

FIG. 5 is a perspective view of the wand adapter of FIG. 2.

FIG. 6 is a perspective view of a replaceable fluid disbursement assembly in accordance with one or more embodiments of the invention.

FIG. 7 is an elevation view, in cross section, of the replaceable fluid disbursement assembly of FIG. 6.

FIG. 8 is a perspective view of a replaceable fluid disbursement assembly in accordance with one or more embodiments of the invention.

FIG. 9 is an elevation view, in cross section, of the replaceable fluid disbursement assembly of FIG. 8.

FIG. 10 is a perspective view of the tube adapter of FIG. 8.

FIG. 11 is a perspective view of the wand adapter of FIG. 8.

FIG. 12 is a perspective view of a replaceable fluid disbursement assembly in accordance with one or more embodiments of the invention.

FIG. 13 is an elevation view, in cross section, of the sanitary quick disconnect coupling of FIG. 12.

FIG. 14 is a perspective view of the tube adapter of FIG. 12.

FIG. 15 is a perspective view of the wand adapter of FIG. 12.

FIG. 16 is an elevation view, in cross section, of a replaceable fluid disbursement assembly in accordance with one or more embodiments of the invention.

FIG. 17 is an elevation view, in cross section, of a replaceable fluid disbursement assembly in accordance with one or more embodiments of the invention.

### DETAILED DESCRIPTION

Preferred embodiments of the invention provide methods and systems for providing a quick disconnect coupling for fluid disbursement devices used in systems with sanitary requirements, such as biological or pharmaceutical reactor vessels. In an illustrative embodiment a fluid disbursement device, such as a sparger, is welded to a tube adapter. An essentially complimentary wand adapter is welded to the intake wand used to supply liquid or gas to a reactor vessel. An O-ring forms an impermeable seal between the wand adapter and the tube adapter. The invention allows the fluid disbursement device to be quickly disconnected from the intake wand and replaced. This is an improvement over the prior art, where the fluid disbursement device is welded to the intake wand, removal is difficult, and replacement requires additional welding.

Additional advantages of the design include that the design of the wand tube adapter and tube adapter does not include threads or other crevices which are difficult to clean in between reaction cycles. The ability to quickly remove and replace the fluid disbursement device attached to the intake wand also means that only one intake wand is required. The device used to disburse liquid or gas during normal operation can be quickly replaced with a spray ball assembly, used to supply high pressure detergents or cleaning fluids, during the cleaning process in between operational cycles of the reactor. At the completion of the cleaning cycle, the spray ball assembly can be quickly replaced with a new fluid disbursement device for the next operational cycle, without requiring any welding.

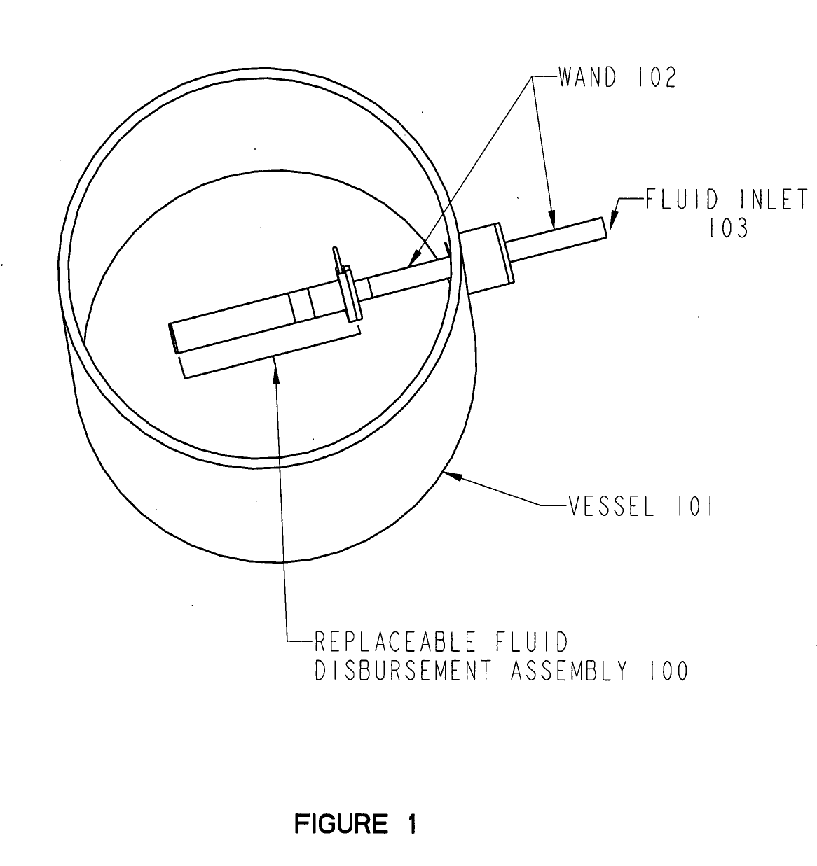

FIG. 1 is a perspective view, partly in cross section, of a replaceable fluid disbursement assembly 100 installed within a reactor vessel 101 in accordance with one or more embodiments of the invention. As discussed above, the replaceable fluid disbursement assembly 100 is attached to a tubular wand 102. The tubular wand 102 passes through the side of the reactor vessel 101. During normal operation liquid or gas enters the tubular wand 102 through fluid inlet 103 and passes into the reactor vessel 101.

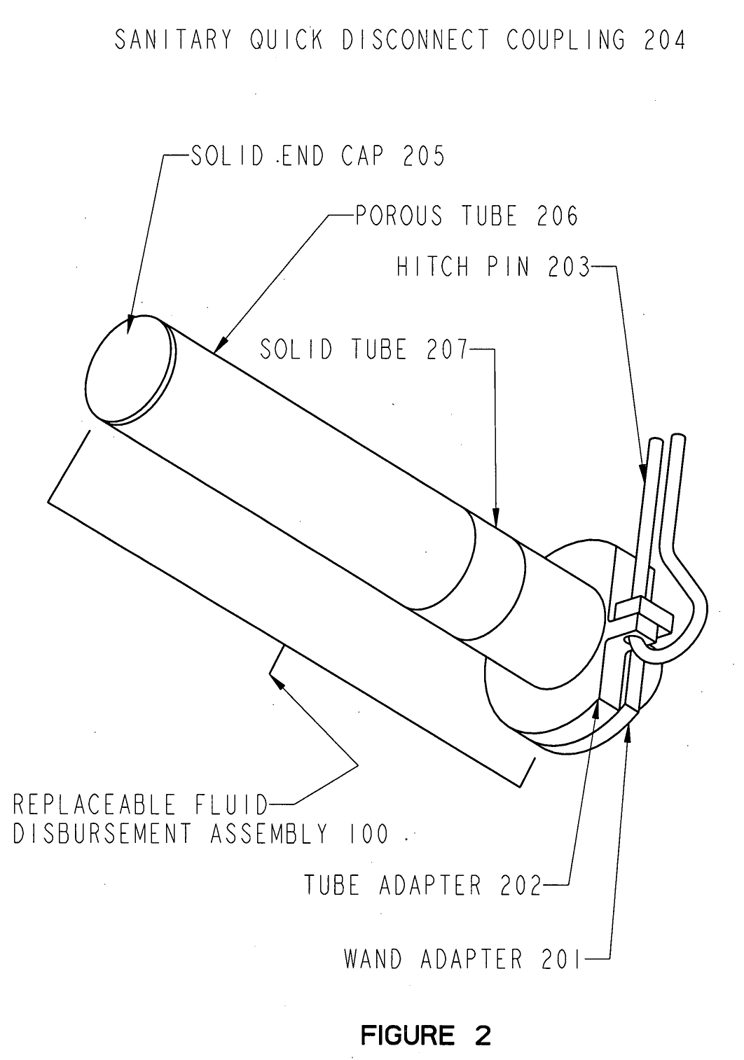

FIG. 2 is a perspective view of a replaceable fluid disbursement assembly 100 attached to a wand adapter 201. The replaceable fluid disbursement assembly 100 shown includes a tube adapter 202, a solid end cap 205, a porous tube 206, and a solid tube extension 207. The tube adapter 202 attaches to the wand adapter 201, and is held in place with a hitch pin 203. The wand adapter 201, tube adapter 202, and hitch pin 203 are collectively referred to as a sanitary quick disconnect coupling 204.

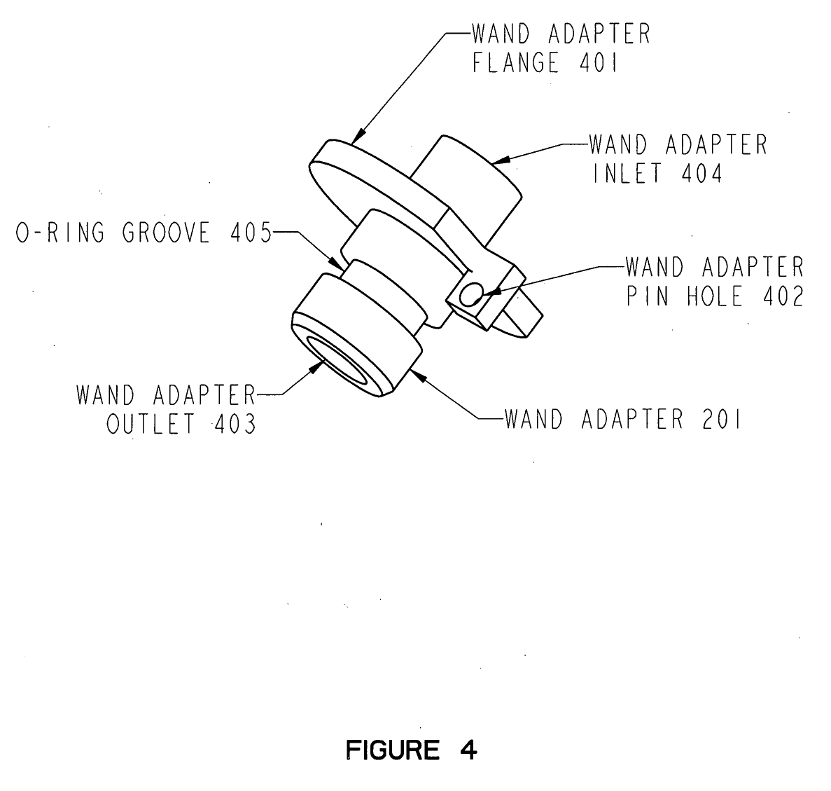

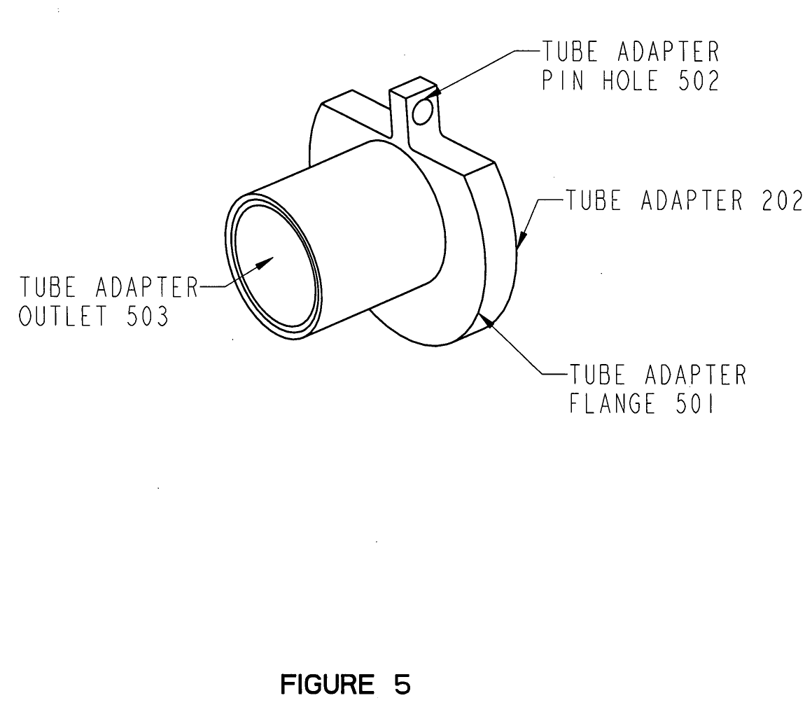

The wand adapter 201 and tube adapter 202 construction details, such as size and material, are a function of the underlying industrial process. For example, the selection of the wall material and thickness will depend on the temperature, pressure, and corrosion properties of the liquid or gas being injected and the properties inside the reactor vessel. Exemplary materials include Inconel®, Hastelloy®, and 316L stainless steel. Inconel is a registered trademark of Huntington Alloys Corporation. Hastelloy is a registered trademark of Haynes International, Inc. Additional materials include carbon steel, aluminum, and copper alloys. Additional details concerning the wand adapter 201 and tube adapter 202 are provided below in the discussion of FIGS. 4 and 5 respectively.

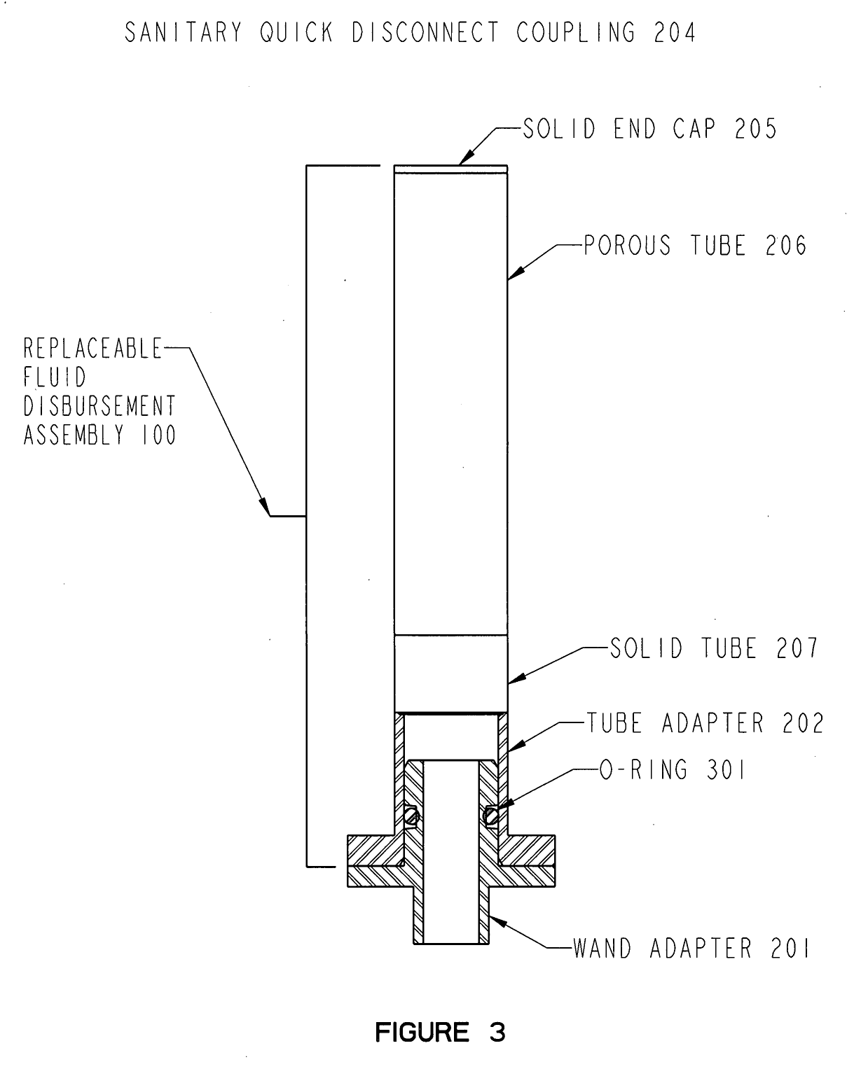

The inlet of the wand adapter 201 is joined to the end of the wand 102 that passes through the side of the reactor vessel, as shown in FIG. 1. The joint between the wand adapter 201 and the wand 102 is welded, or otherwise constructed, to be impermeable to the liquid or gas being injected into the reactor vessel. Likewise, the tube adapter 202 is joined to the solid tube 207. The joint between the tube adapter 202 and the solid tube 207 is also welded, or otherwise constructed, to be impermeable to the liquid or gas being injected into the reactor vessel. Finally, when the tube adapter 202 and the wand adapter 201 are joined together, the connection is again impermeable. Additional details of this connection will be described in more detail below with respect to FIG. 3. This means that the only contact between the liquid or gas flowing from the exterior of the reactor vessel to the interior of the reactor vessel is through the porous tube 206.

The tube adapter 202 and wand adapter 201 are held together with a hitch pin 203. The hitch pin 203 passes though holes in the flanges of the tube adapter 202 and the wand adapter 201. The hitch pin 203 prevents the tube adapter 202 and the wand adapter 201 from separating as high pressure gas is injected through the wand and tube adapter assemblies into the reactor vessel.

The replaceable fluid disbursement assembly 100 shown includes a tube adapter 202, a solid end cap 205, a porous tube 206, and a solid tube extension 207. Again, the construction details of the porous tube 206, such as size and material, are well known in the industry and are, again, a function of the underlying industrial process. For example, the porous tube 206 can be manufactured of ceramic material or sintered metal. In addition, the assembly connected to the tube adapter 202 is not limited to tubular shapes and can include fabric candles, spray balls, or other types of fluid disbursement assemblies. The solid tube extension 207 is used to place the porous tube 206 at the proper location in the interior reactor vessel away from the vessel wall. Again, the particular distance will be a function of the underlying industrial process.

FIG. 3 is an elevation view, in cross section, of the replaceable fluid disbursement assembly 100 of FIG. 2. FIG. 3 again shows the wand adapter 201, and the replaceable fluid disbursement assembly 100, including the tube adapter 202. In addition FIG. 3 shows an O-ring 301. The O-ring 301 is preferably any industry standard O-ring, but may also be a flat gasket or sleeve and bushing assembly. The selection of the material and thickness will depend on the temperature, pressure, and corrosion properties of the liquid or gas being injected and the properties inside the reactor vessel. The diameter of the O-ring 301 is dependent on the size of the wand adapter 201 and tube adapter 202. The O-ring 301 is placed between the wand adapter 201 and the tube adapter 202, completely surrounding the perimeter of the wand adaptor 201. The O-ring 301 forms an impermeable boundary between the wand adapter 201 and the tube adapter 202. This means that the only contact between the liquid or gas flowing from the exterior of the reactor vessel to the interior of the reactor vessel is through the porous tube 206.

FIG. 4 is a perspective view of the wand adapter 201 of FIG. 2. The wand adapter 201 includes a wand adapter flange 401, a wand adapter fastener hole 402, a wand adapter outlet 403, a wand adapter inlet 404, and an O-ring groove 405. As noted above, the wand adapter 201 construction details, such as size and material, are a function of the underlying industrial process. For example, the selection of the wall material and thickness will depend on the temperature, pressure, and corrosion properties of the liquid or gas being injected and the properties inside the reactor vessel. Exemplary materials include Inconel®, Hastelloy®, and 316L stainless steel. Inconel is a registered trademark of Huntington Alloys Corporation. Hastelloy is a registered trademark of Haynes International, Inc. Additional materials include carbon steel, aluminum, and copper alloys.

In an exemplary embodiment, the wand adapter 201 is 1.2 inches long and is constructed of electropolished 316L stainless steel, with a surface finish roughness average of at least 20 Ra. The wand adapter flange 401 is 0.14 inches thick and has an outer diameter of 1 and ⅜ inches. The wand adapter fastener hole 402 has a diameter of 0.13 inches. The wand adapter outlet 403 is 0.69 inches long with an inner diameter of 0.37 inches and an outer diameter of 0.623 inches. The wand adapter inlet 404 is 0.37 inches long with an inner diameter of 0.37 inches and an outer diameter of 0.5 inches. The O-ring groove 405 is 0.14 inches wide and 0.08 inches deep.

The wand adapter flange 401 provides structural support when placed against the corresponding tube adapter flange. In addition the wand adapter flange 401 provides a suitable location for the wand adapter fastener hole 402. The wand adapter outlet 403 and wand adapter inlet 404 allow the process liquid or gas to flow from the wand 101, through the wand adapter 201, and to the interior of the tube adapter 202. The O-ring groove 405 holds O-ring 301 in place, thus forming an impermeable seal between the wand adapter 201 and the tube adapter 202.

FIG. 5 is a perspective view of the tube adapter 202 of FIG. 2. The tube adapter 202 includes a tube adapter flange 501, a tube adapter fastener hole 502, and a tube adapter opening 503. As noted above, the tube adapter 202 construction details, such as size and material, are a function of the underlying industrial process. For example, the selection of the wall material and thickness will depend on the temperature, pressure, and corrosion properties of the liquid or gas being injected and the properties inside the reactor vessel. Exemplary materials include Inconel®, Hastelloy®, and 316 stainless steel. Inconel is a registered trademark of Huntington Alloys Corporation. Hastelloy is a registered trademark of Haynes International, Inc. Additional materials include carbon steel, aluminum, and copper alloys.

In an exemplary embodiment, the tube adapter 202 is 1.0 inches long and is constructed of electropolished 316L stainless steel, with a surface finish roughness average of at least 20 Ra. The tube adapter flange 501 is 0.20 inches thick and has an outer diameter of 1 and ⅜ inches. The tube adapter fastener hole 502 has a diameter of 0.13 inches. The tube adapter outlet 503 is 0.80 inches long with an inner diameter of 0.625 inches and an outer diameter of 0.75 inches.

The tube adapter outlet 503 runs the entire axial distance of the tube adapter 202. The inner diameter of the tube adapter outlet 503 is sized (0.625 inches in diameter) such that the wand adapter outlet 403 (0.623 inches in diameter) just fits. Thus the tube adapter 202 fits around the wand adapter 201. The O-ring 301, as mentioned above, forms an impermeable seal between the interior of the wand and tube adapters and the interior of the reactor vessel. This allows the process gas or fluid to flow from the wand adapter 201, through the tube adapter 202, to the interior of the porous tube 206, and then into the interior of the reactor vessel 101.

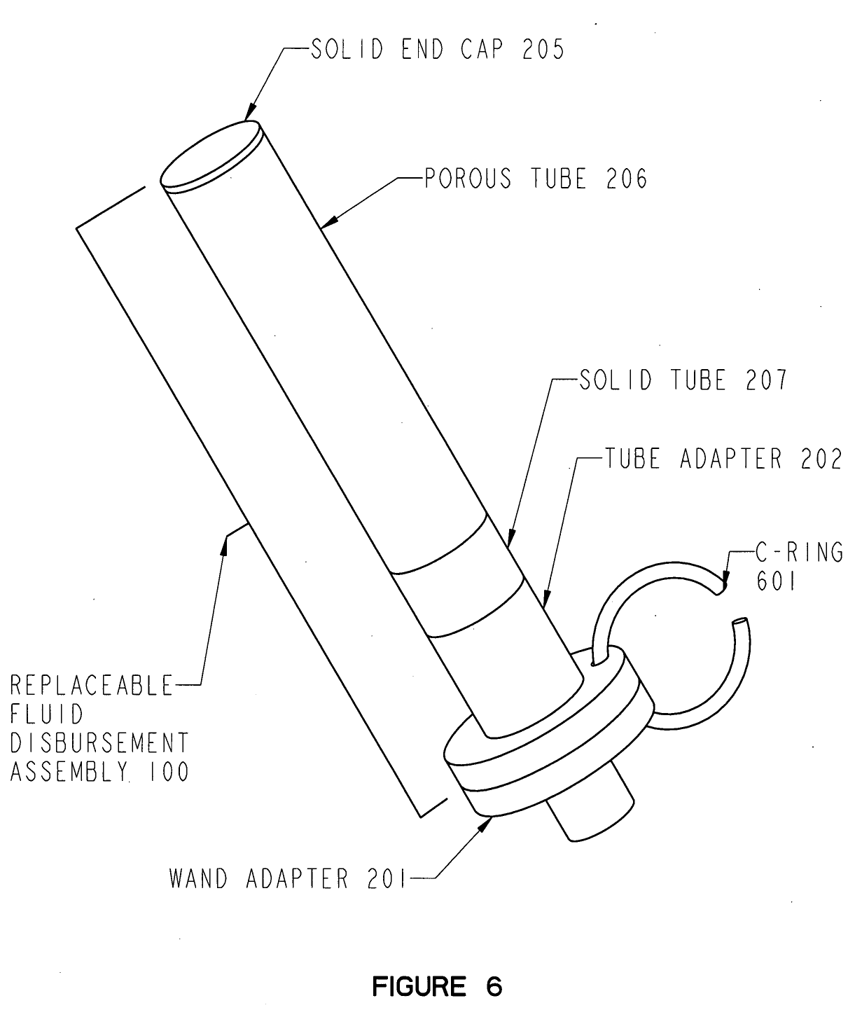

FIG. 6 is a perspective view of replaceable fluid disbursement assembly 100 in accordance another embodiment of the invention. In this embodiment, the wand adapter fastener hole 402 and tube adapter fastener hole 502 are now aligned axially with the wand adapter 201 and tube adaptor 202. Also, the hitch pin 203 has been replaced with a C-ring 601. This variation allows for easier machining of the wand adapter flange 401 and tube adapter flange 501. The design choices between axially or transverse fastener hole locations and the use of a hitch pin 203 or C-ring 601 are influenced by the underlying industrial process, the reactor vessel design, and the particular placement of the wand adapters 201 within the reactor vessel. For example, in cases where the wand adapter 201 is placed near other elements within a reactor vessel, there may not be enough space to allow a hitch pin 203 to be inserted in the transverse direction.

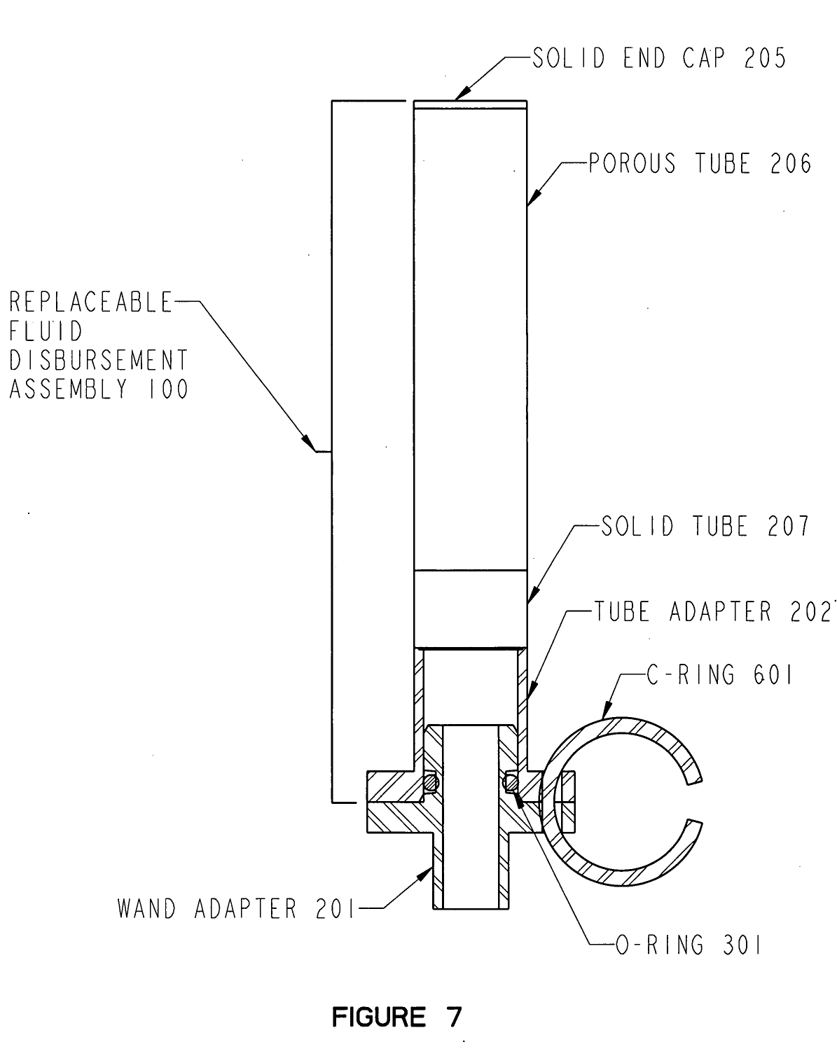

FIG. 7 is an elevation view, in cross section, of the replaceable fluid disbursement assembly 100 of FIG. 6. This figure shows the wand adapter fastener hole 402 and tube adapter fastener hole 502 axially aligned with the wand adapter 201 and tube adapter 202.

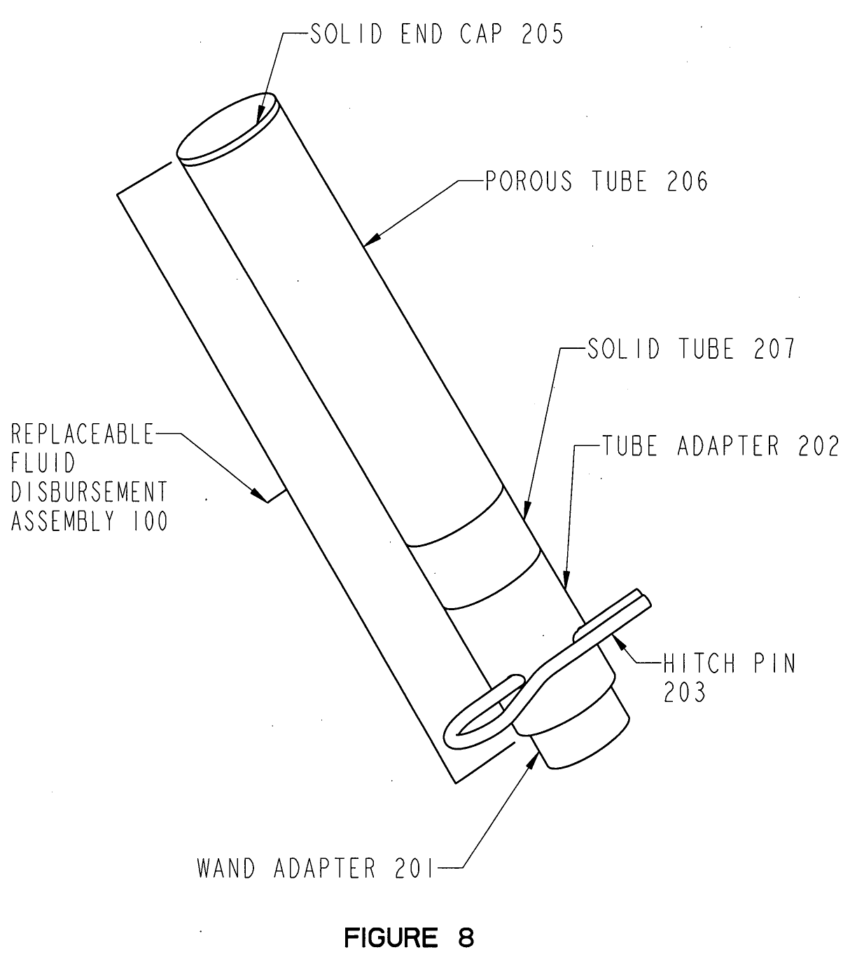

FIG. 8 is a perspective view of a replaceable fluid disbursement assembly 100 in accordance with another embodiment of the invention. In this embodiment, the wand adapter flange 401 and tube adaptor flange 501 are eliminated. The wand adapter fastener hole 402 and tube adapter fastener hole 502 are now located in the side walls of the wand adapter 201 and tube adaptor 202. This implementation requires that the side walls be of sufficient thickness to support the forces on the hitch pin 203, in addition to the usual forces applied due to the pressure of the liquid or gas being injected and the properties inside the reactor vessel.

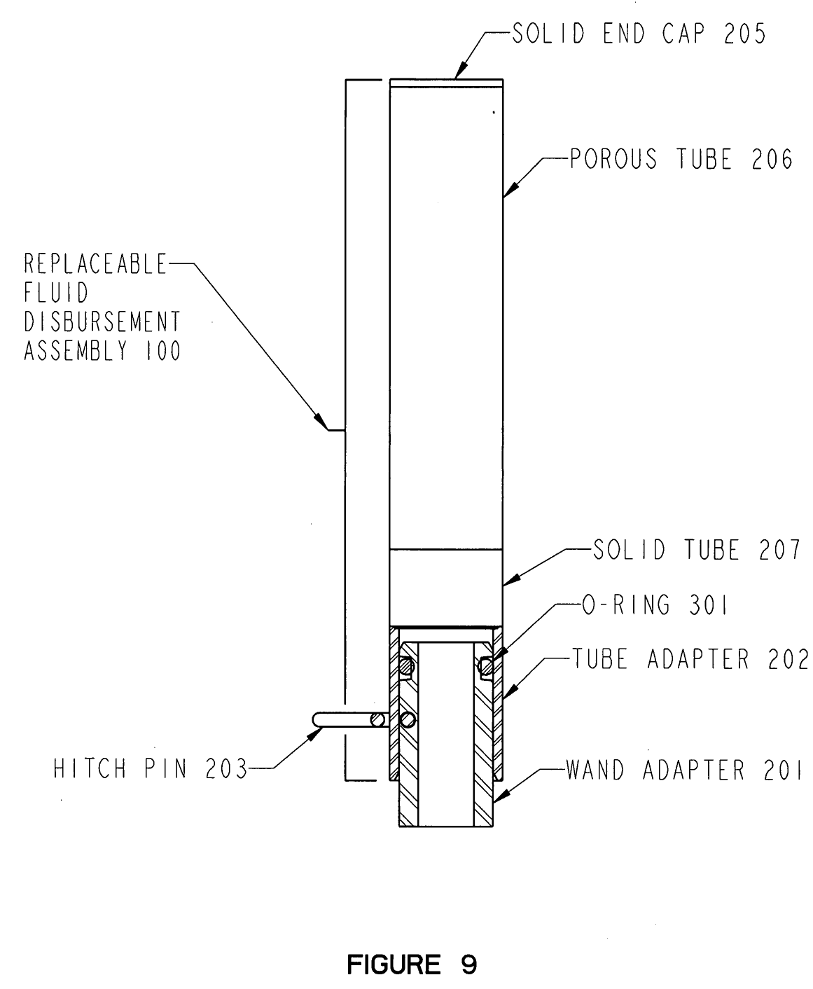

FIG. 9 is an elevation view, in cross section, of the replaceable fluid disbursement assembly 100 of FIG. 8. The O-ring 301 is again placed between the wand adapter 201 and the tube adapter 202. The wand and tube adapter fastener holes are located on the reactor vessel side of the O-ring 301 and the O-ring 301 still forms an impermeable seal between incoming liquid or gas and the interior of the reactor vessel. Thus the incoming gas or fluid must enter the reactor vessel through the porous tube 206.

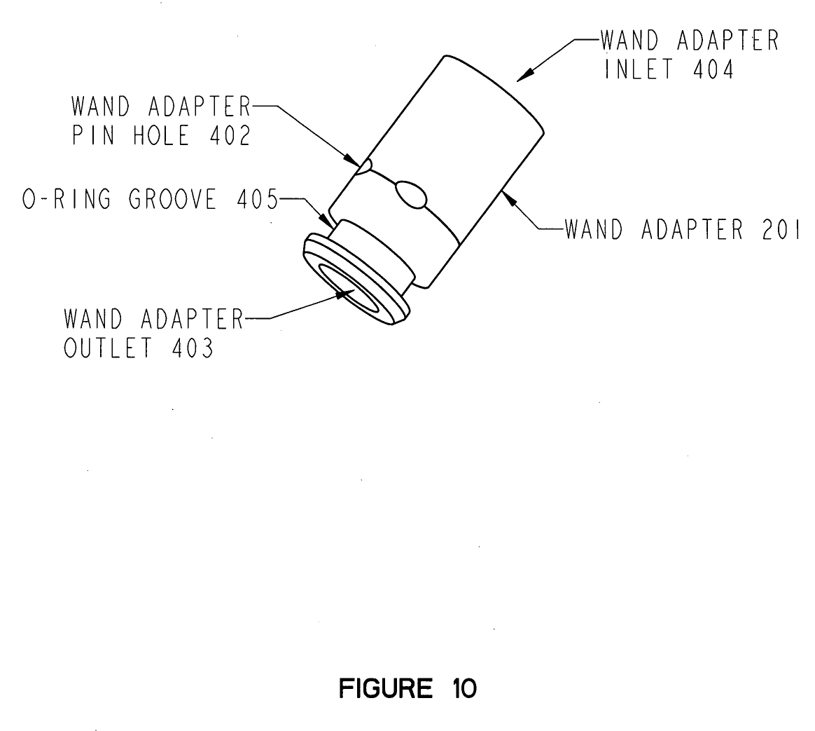

FIG. 10 is a perspective view of the wand adapter 201 of FIG. 8. As noted above, the wand adapter flange 401 is eliminated. The wand adapter fastener hole 402 is now placed through the side wall of the wand adapter 201.

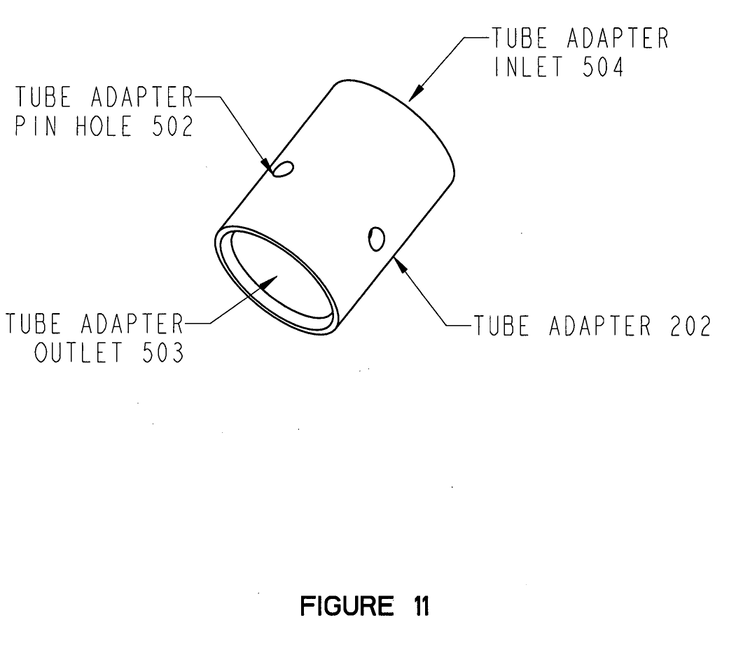

FIG. 11 is a perspective view of the tube adapter 202 of FIG. 8. As noted above, the tube adaptor flange 501 is eliminated. The tube adapter fastener hole 502 is now placed through the side wall of tube adaptor 202.

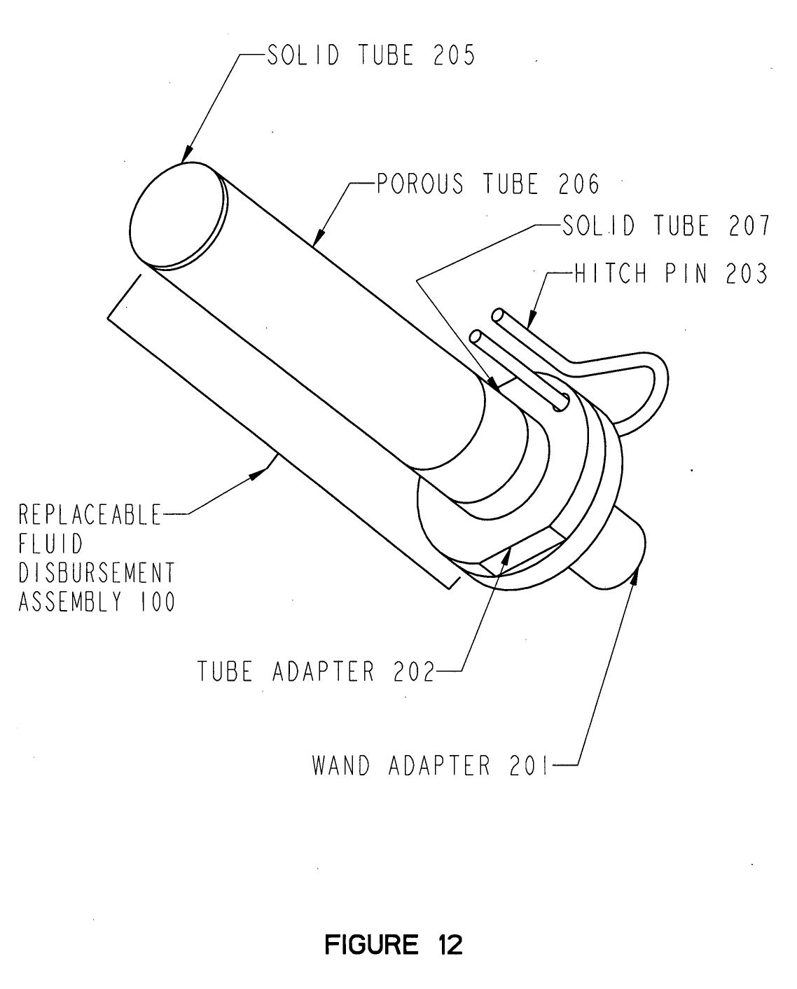

FIG. 12 is a perspective view of a replaceable fluid disbursement assembly 100 in accordance with another embodiment of the invention. In this embodiment, the wand adapter fastener hole 402 and tube adapter fastener hole 502 are again aligned axially with the wand adapter 201 and tube adaptor 202, as described in FIG. 6 above. However, unlike FIG. 6, a hitch pin 203 is used, rather than a C-ring 601. As noted above, the design choices between axially or transverse fastener hole locations and the use of a hitch pin 203 or a C-ring 601 are influenced by the underlying industrial process, the reactor vessel design, and the particular placement of the wand adapters 201 and tube adapters 202 within the reactor vessel.

FIG. 12 additionally shows the tube adapter flange 501 constructed with two opposing flat edges. This allows for wrenches and other standard tools to be used when installing, or replacing fluid disbursement assemblies.

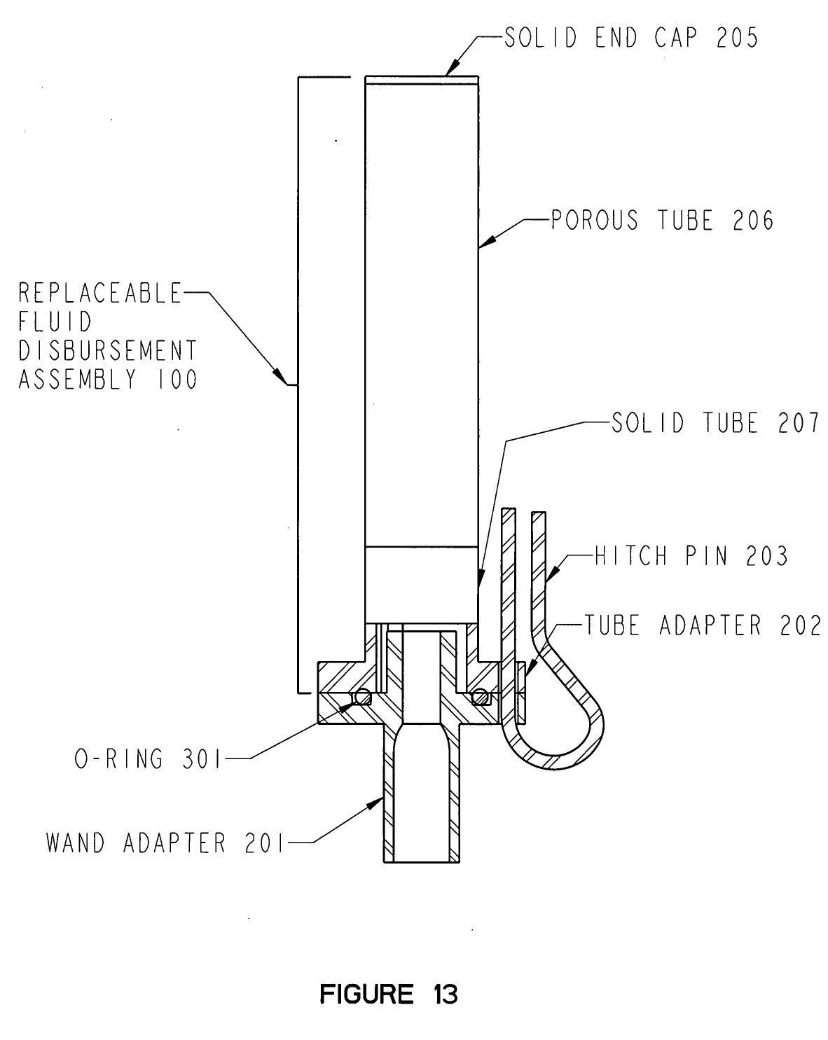

FIG. 13 is an elevation view, in cross section, of the replaceable fluid disbursement assembly 100 of FIG. 12. In this embodiment, the O-ring 301 is in a different location than that shown in FIG. 7. The O-ring 301 is located between the wand adapter flange 401 and the tube adaptor flange 501. This decreases the wetted area between the wand adapter flange 401 and the tube adaptor flange 501 exposed to the interior of the reactor vessel at the expense of a larger diameter O-ring 301.

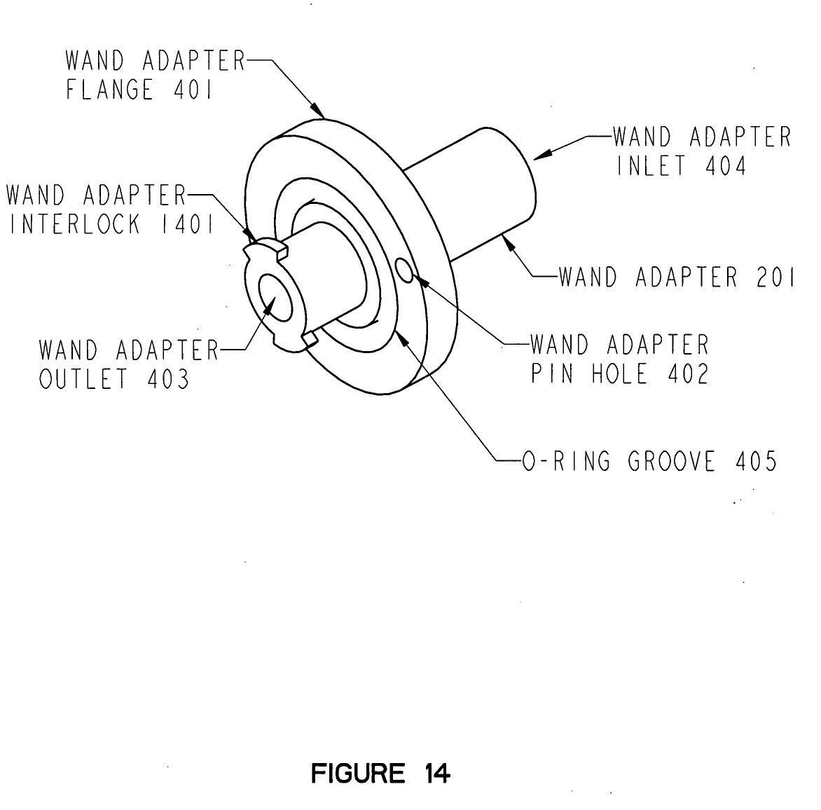

FIG. 14 is a perspective view of the wand adapter 201 of FIG. 12. Like the wand adapters 201 described previously, the wand adapter 201 includes a wand adapter flange 401, a wand adapter fastener hole 402, a wand adapter outlet 403, a wand adapter inlet 404, and an O-ring groove 405. In addition, FIG. 14 shows a wand adapter interlock 1401. This wand adapter interlock 1401 is required due to the location of the O-ring groove 405 between the wand adapter flange 401 and the tube adaptor flange 501. Any axial movement between the wand adapter 201 and the tube adapter 202 could break the impermeable barrier formed by O-ring 301, by creating additional space between the two flanges.

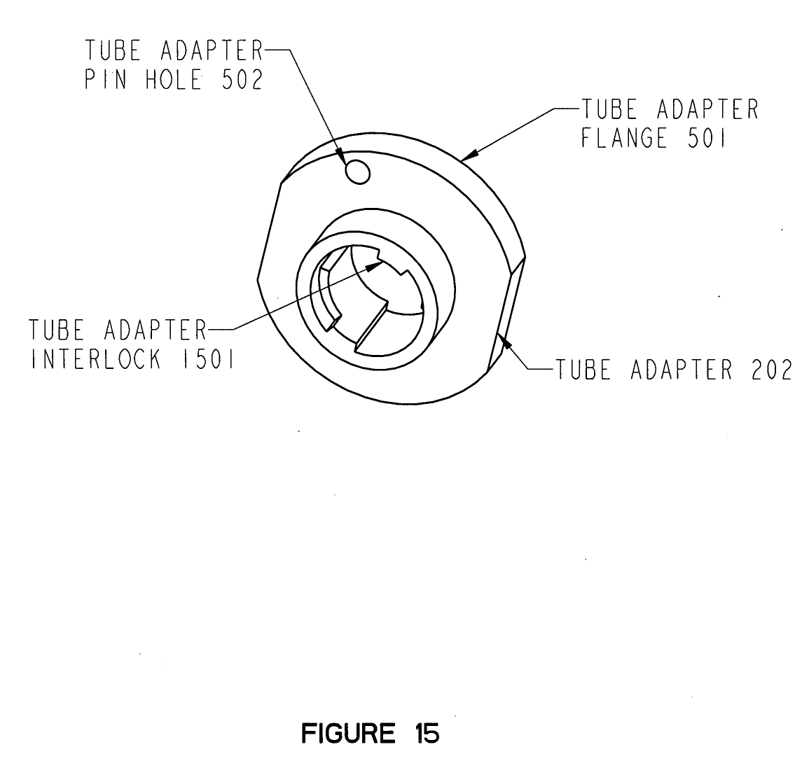

FIG. 15 is a perspective view of the tube adapter 202 of FIG. 12. Like the tube adapters 202 described preciously, the tube adapter 202 includes a tube adapter flange 501, a tube adapter fastener hole 502, and a tube adapter opening 503. In addition, FIG. 15 shows a tube adapter interlock 1501. As noted above, due to the placement of O-ring 301, any axial movement between the wand adapter 201 and the tube adapter 202 could break the impermeable barrier formed by O-ring 301. The tube adapter interlock 1501 mates with the wand adapter interlock 1401 to prevent such movement. During installation of the fluid disbursement assembly 100 and the tube adapter 202 on the wand adapter 201, the tube adapter 202 is rotated such that the protrusions on the wand adapter interlock 1401 engage groves in the tube adapter interlock 1501. The hitch pin 203 is inserted through the fastener holes 402 and 502 to prevent the rotation of the tube adapter 202 after installation.

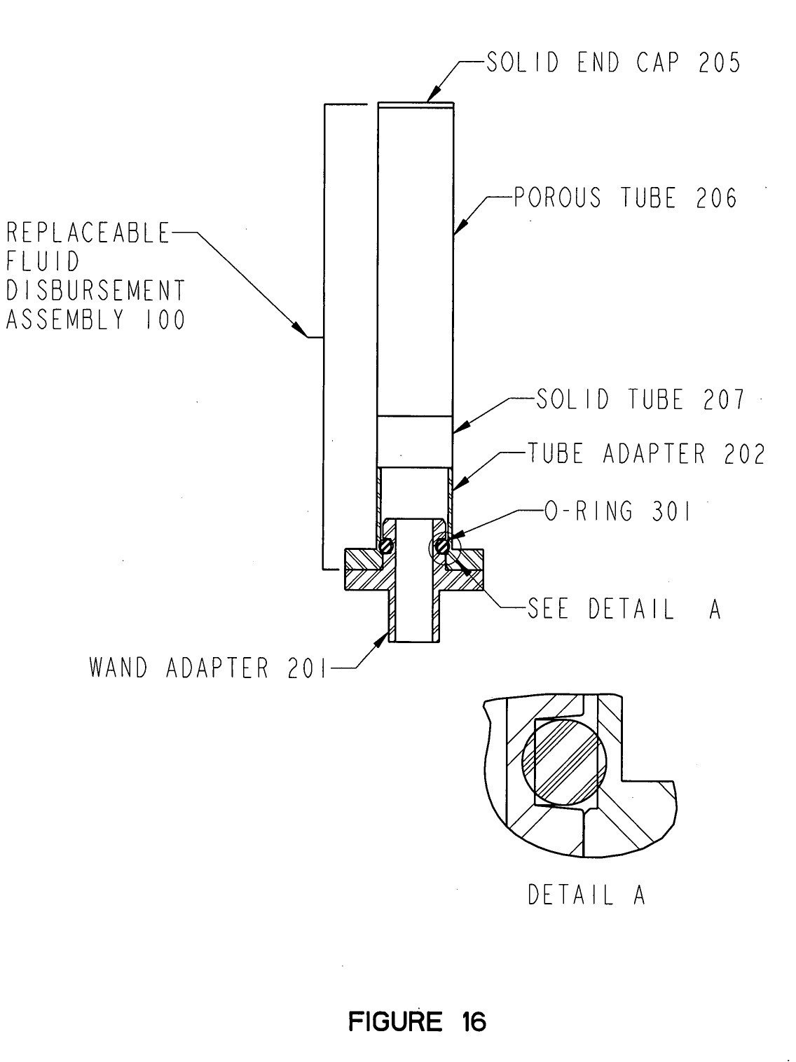

FIG. 16 is an elevation view, in cross section, of a replaceable fluid disbursement assembly 100 in accordance with another embodiment of the invention. In this embodiment, the wand adapter fastener hole 402 and tube adapter fastener hole 502 have been eliminated. Unlike embodiments described previously, the inner diameter (ID) of the tube adapter 202 is not constant along the axial length of the tube adapter 202. As shown in Detail A, the inner diameter of the tube adapter 202 is smaller at the inlet and larger at the outlet. This change in diameter forms a lip which interlocks with the O-ring 301. During installation of the replaceable fluid disbursement assembly 100, the O-ring 301 is compressed by the inner diameter lip. Once the lip clears the O-ring 301, the O-ring 301 expands and forms an impermeable boundary between the wand adapter 201 and the tube adapter 202. This means that the only contact between the liquid or gas flowing from the exterior of the reactor vessel to the interior of the reactor vessel is through the porous tube 206.

As discussed above the O-ring 301 is preferably any industry standard O-ring where the selection of the material and thickness will depend on the temperature, pressure, and corrosion properties of the liquid or gas being injected and the properties inside the reactor vessel. The diameter of the O-ring 301 is dependent on the size of the wand adapter 201 and tube adapter 202. In addition, the O-ring 301 material must be sufficiently stiff to prevent the fluid disbursement assembly 100 from sliding off the wand adapter 201. Like previous embodiments, the O-ring 301 is placed between the wand adapter 201 and the tube adapter 202, completely surrounding the perimeter of the wand adaptor 201. The O-ring 301 forms an impermeable boundary between the wand adapter 201 and the tube adapter 202. This means that the only contact between the liquid or gas flowing from the exterior of the reactor vessel to the interior of the reactor vessel is through the porous tube 206.

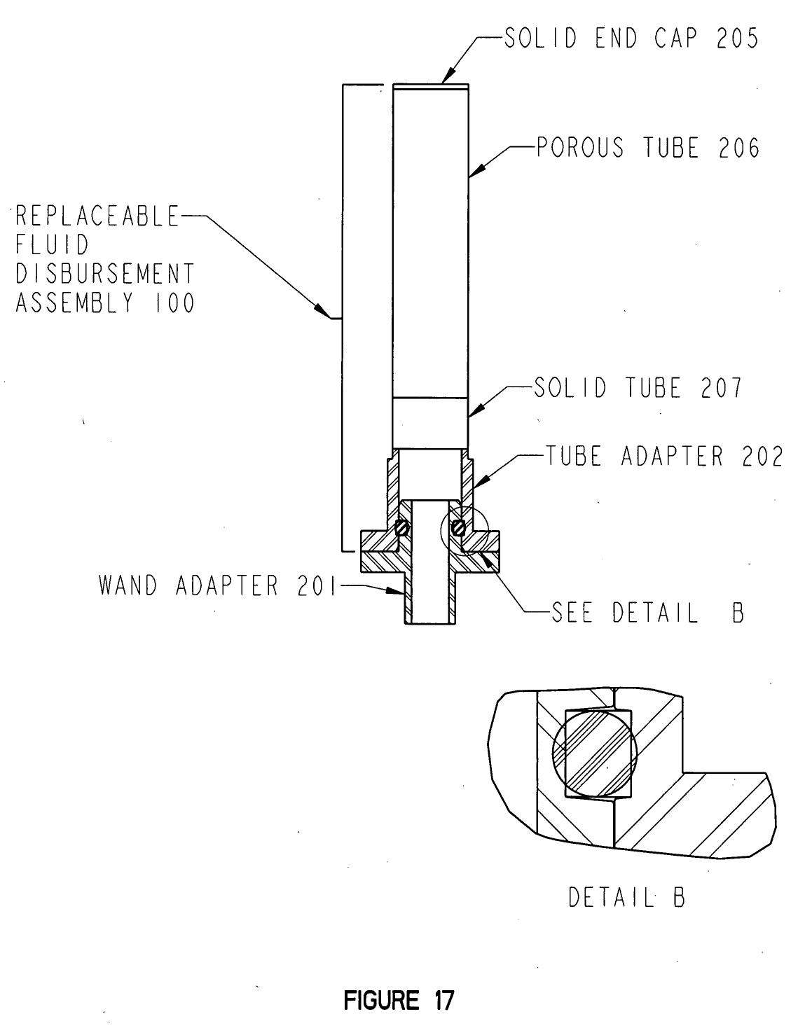

FIG. 17 is an elevation view, in cross section, of a replaceable fluid disbursement assembly 100 in accordance with another embodiment of the invention. In this embodiment, the wand adapter fastener hole 402 and tube adapter fastener hole 502 have been eliminated. Like embodiments described previously, the inner diameter (ID) of the tube adapter 202 is essentially constant along the axial length of the tube adapter 202. However, as shown in Detail B, the tube adapter 202 has an O-ring groove. The tube adapter O-ring grove is aligned with the wand adapter O-ring groove. During installation of the replaceable fluid disbursement assembly 100, the O-ring 301 is compressed by the inner diameter lip. Once the lip clears the O-ring 301, the O-ring 301 expands and forms an impermeable boundary between the wand adapter 201 and the tube adapter 202. This means that the only contact between the liquid or gas flowing from the exterior of the reactor vessel to the interior of the reactor vessel is through the porous tube 206.

The O-ring 301 shown in FIG. 17, as discussed above, is preferably any industry standard O-ring where the selection of the material and thickness will depend on the temperature, pressure, and corrosion properties of the liquid or gas being injected and the properties inside the reactor vessel. The diameter of the O-ring 301 is dependent on the size of the wand adapter 201 and tube adapter 202. In addition, the O-ring 301 material must be sufficiently stiff to prevent the fluid disbursement assembly 100 from sliding off the wand adapter 201. Like previous embodiments, the O-ring 301 is placed between the wand adapter 201 and the tube adapter 202, completely surrounding the perimeter of the wand adaptor 201. The O-ring 301 forms an impermeable boundary between the wand adapter 201 and the tube adapter 202. This means that the only contact between the liquid or gas flowing from the exterior of the reactor vessel to the interior of the reactor vessel is through the porous tube 206.

As described above, preferred embodiments of the invention provide methods and systems for providing a replaceable fluid disbursement assembly used in systems with sanitary requirements, such as biological or pharmaceutical reactor vessels. The methods and systems do not require a weld between the replaceable fluid disbursement assembly and the intake wand of the reactor vessel. As such, the replaceable fluid disbursement assembly can be quickly disconnected from the intake wand of the reactor vessel. In addition, the O-ring seal can be disposed of and replaced with a new seal at the same time. The ability to quickly remove and replace the fluid disbursement assembly attached to the intake wand also means that only one intake wand is required for both the operational cycles and the cleaning process in between the operational cycles.

In some embodiments, compressive force between the O-ring seal and the wand adapter and tube adapter holds the replaceable fluid disbursement assembly in place. In other embodiments a hitch pin, or other similar device, is used to provide a mechanical restraint and prevent the separation of the wand adapter and the tube adapter. Therefore, the wand and tube adapters do not have threads or other crevices which are difficult to clean in between reaction cycles. In addition, the hitch pin itself is not threaded. This satisfies the sanitary requirements of the underlying biological or pharmaceutical reaction process.

While the invention has been described with reference to specific embodiments in the biotechnology and pharmaceutical industries, the description is illustrative of the invention and in not to be construed as limiting. The invention is applicable to any application which cleaning in place or high purity requirements such as those in the food and beverage industry, chemical manufacturing, or semiconductor manufacturing.

What is claimed is:

1. A system for easily replacing fluid disbursement devices used in a sanitary bioreactor, the system comprising:
a fluid disbursement device for disbursing fluid into a sanitary bioreactor;
a tube adapter having an interior surface defining an axially extending passage between a first end and a second end of the tube adapter, and an exterior surface containing a fastener hole; wherein the fluid disbursement device and the second end of the tube adapter are fixed together;
a wand adapter having an interior surface defining an axially extending passage between a first end and a second end of the wand adapter, and an exterior surface containing a fastener hole; wherein the tube adapter and wand adapter are releasably connected, the interior surface of the tube adapter is essentially complementary to the exterior surface of the wand adapter, and the wand adapter fastener hole and the tube adapter fastener hole are aligned;
at least one O-ring grove, shaped to receive an O-ring such that the O-ring provides a fluid impermeable boundary between the wand adapter and the tube adapter; and
a fastener that passes through the wand adapter fastener hole and the tube adapter fastener hole.

2. The system of claim 1 wherein the O-ring groove is located on the exterior surface of the wand adapter proximate to the second end of the wand adapter.

3. The system of claim 1 wherein the O-ring groove is located on the interior surface of the tube adapter proximate to the first end of the tube adapter.

4. The system of claim 1 wherein the wand adapter additionally includes a flange and wherein the tube adapter additionally includes a flange.

5. The system of claim 4 wherein the O-ring groove is located on the exterior surface of the wand adapter proximate to the second end of the wand adapter.

6. The system of claim 4 wherein the O-ring groove is located on the interior surface of the tube adapter proximate to the first end of the tube adapter.

7. The system of claim 4 wherein the O-ring grove is located on the wand adapter flange.

8. The system of claim 4 wherein the O-ring grove is located on the tube adapter flange.

9. The system of claim 4 wherein a first O-ring groove is located on the exterior surface of the wand adapter proximate to the second end of the wand adapter and a second O-ring groove is located on the wand adapter flange.

10. The system of claim 4 wherein a first O-ring groove is located on the exterior surface of the wand adapter proximate to the second end of the wand adapter and a second O-ring groove is located on the tube adapter flange.

11. The system of claim 4 wherein a first O-ring groove is located on the interior surface of the tube adapter proximate to the first end of the tube adapter and a second O-ring groove is located on the wand adapter flange.

12. The system of claim 4 wherein a first O-ring groove is located on the interior surface of the tube adapter proximate to the first end of the tube adapter and a second O-ring groove is located on the tube adapter flange.

13. The system of claim 1, claim 2, claim 3, claim 4, claim 5, claim 6, claim 7, claim 8, claim 9, claim 10, claim 11, or claim 12 wherein the wand adapter fastener hole is a groove.

14. A method for easily replacing fluid disbursement devices used in a sanitary bioreactor, the bioreactor employing fluid inlet wands with wand adapters, the method comprising:
providing a fluid disbursement device for disbursing fluid into a sanitary bioreactor;
providing a tube adapter having an interior surface defining an axially extending passage between a first end and a second end of the tube adapter, wherein the fluid disbursement device and the second end of the tube adapter are fixed together;
providing at least one O-ring grove, shaped to receive an O-ring such that the O-ring provides a fluid impermeable boundary between the wand adapter and the tube adapter; and
releasably connecting the tube adapter and wand adapter.

15. A system for easily replacing fluid disbursement devices used in a sanitary bioreactor, the system comprising:
a fluid disbursement device for disbursing fluid into a sanitary bioreactor;
a tube adapter having an interior surface defining an axially extending passage between a first end and a second end of the tube adapter, wherein the fluid disbursement device and the second end of the tube adapter are fixed together;
a wand adapter having an interior surface defining an axially extending passage between a first end and a second end of the wand adapter, wherein the tube adapter and wand adapter are releasably connected and the interior surface of the tube adapter is essentially complementary to the exterior surface of the wand adapter; and
at least one O-ring grove, shaped to receive an O-ring such that the O-ring provides a fluid impermeable boundary between the wand adapter and the tube adapter.

16. The system of claim 15 wherein a first O-ring groove is located on the exterior surface of the wand adapter proximate to the second end of the wand adapter, a second O-ring groove is located on the interior surface of the tube adapter proximate to the first end of the tube adapter, and the first and second O-ring grooves are aligned.

17. The system of claim 15 wherein an O-ring groove is located on the exterior surface of the wand adapter proximate to the second end of the wand adapter and wherein the first end inner diameter of the tube adapter is smaller than the second end inner diameter.

18. The system of claim 15 wherein an O-ring groove is located on the interior surface of the tube adapter proximate to the first end of the tube adapter and wherein the second end outer diameter of the wand adapter is larger than the first end outer diameter of the wand adapter.

19. The system of claim 15, claim 16, claim 17, or claim 18 wherein the wand adapter additionally includes a flange and wherein the tube adapter additionally includes a flange.

20. The system of claim 15 wherein the tube adapter includes a tube adapter interlock and the wand adapter includes a wand adapter interlock.

21. The system of claim 20 wherein the O-ring groove is located on the exterior surface of the wand adapter proximate to the second end of the wand adapter.

22. The system of claim 20 wherein the O-ring groove is located on the interior surface of the tube adapter proximate to the first end of the tube adapter.

23. The system of claim 20 wherein the wand adapter additionally includes a flange, the tube adapter additionally includes a flange, and the O-ring groove is located on the tube adapter flange.

24. The system of claim 20 wherein the wand adapter additionally includes a flange, the tube adapter additionally includes a flange, and the O-ring groove is located on the wand adapter flange.

25. A sanitary quick disconnect coupling for use in a bioreactor comprising:
a tube adapter having an interior surface defining an axially extending passage between a first end and a second end of the tube adapter, and an exterior surface containing a fastener hole;
a wand adapter having an interior surface defining an axially extending passage between a first end and a second end of the wand adapter, and an exterior surface containing a fastener hole; wherein the tube adapter and wand adapter are releasably connected, the interior surface of the tube adapter is essentially complementary to the exterior surface of the wand adapter, and the wand adapter fastener hole and the tube adapter fastener hole are aligned;
at least one O-ring grove, shaped to receive an O-ring such that the O-ring provides a fluid impermeable boundary between the wand adapter and the tube adapter; and
a fastener that passes through the wand adapter fastener hole and the tube adapter fastener hole.
